(19) United States
(12) Patent Application Publication
(10) Pub. No.: US 2023/0295418 A1
(43) Pub. Date: Sep. 21, 2023

(54) EPOXY RESIN COMPOUND FOR PULTRUSION OF COMPOSITES AND PREPARATION METHOD THEREOF

(71) Applicant: Nanjing Hitech Composites Co., Ltd., Nanjing (CN)

(72) Inventors: Hui Wang, Nanjing (CN); Chengyun Lei, Nanjing (CN); Bin Sun, Nanjing (CN); Zhaoding Bao, Nanjing (CN); Lili Zhang, Nanjing (CN)

(21) Appl. No.: 18/322,977

(22) Filed: May 24, 2023

Related U.S. Application Data
(63) Continuation of application No. PCT/CN2023/081486, filed on Mar. 15, 2023.

(30) Foreign Application Priority Data
May 16, 2022 (CN) 202210528459.3

(51) Int. Cl. C08L 63/00

(52) U.S. Cl. CPC C08L 63/00; C08L 2205/02

(57) ABSTRACT

The present invention discloses an epoxy resin compound for pultrusion of composites and a preparation method thereof, and relates to the technical field of epoxy resin material. The epoxy resin compound in the present invention is composed of a component A and a component B at a weight ratio of 100:(80-120), wherein the component A is prepared from bisphenol A epoxy resin, low viscosity epoxy resin, a wetting dispersant, a defoamer and an internal mold discharging agent in proportion, and the component B is prepared from liquid anhydride, a toughening agent, a general accelerator and a latent accelerator in proportion. The epoxy resin compound in the present invention is used for the pultrusion technology of composites, adopts a dual-accelerator curing system and has the characteristics of long application period, high curing speed after triggering at medium and high temperature, and good mechanical properties of cured materials.

### TECHNICAL FIELD

The present invention belongs to the technical field of epoxy resin processing, and particularly relates to an epoxy resin compound for pultrusion of composites and a preparation method thereof. The resin system can be used for preparing structural materials such as pultrusion plates for main beams of wind turbine blades, carbon fiber pultrusion plates for engineering reinforcement and reinforcement material.

### BACKGROUND

Epoxy resin is an excellent thermosetting resin, and has excellent physical properties, chemical corrosion resistance, electrical insulation properties, heat resistance and excellent bonding properties.

The pultrusion technology of composites is an important method for manufacturing high performance composites. The pultrusion technology is a processing mode in which continuous fibers are wetted by resin and then pulled out by a heating mold. The pultrusion technology requires the resin to have the characteristics of high reaction speed, low viscosity and long pot life. For the epoxy resin compound, although a resin system with liquid anhydride as a curing agent has low viscosity and long application period, high-temperature long-time curing is often needed. Therefore, the current epoxy resin compound made from liquid anhydride is difficult to satisfy the performance requirements of the pultrusion technology.

### SUMMARY

In view of the defects of the prior art, the present invention provides an epoxy resin compound for pultrusion of composites. The epoxy resin compound adopts a dual-accelerator curing system, has the characteristics of long application period, high curing speed after triggering at medium and high temperature, and good mechanical properties of cured materials, and can satisfy the application needs of the pultrusion technology.

The epoxy resin compound for pultrusion of composites in the present invention is composed of a component A and a component B at a weight ratio of 100:(80-120);
the component A is composed of the following raw materials in parts by weight:
bisphenol A epoxy resin: 25-75 parts,
low viscosity epoxy resin: 25-75 parts,
wetting dispersant: 1-20 parts,
defoamer: 0.01-1 part,
internal mold discharging agent: 1-10 parts,
the component B is composed of the following raw materials in parts by weight:
liquid anhydride: 50-100 parts,
toughening agent: 1-10 parts,
general accelerator: 0.1-3 parts,
latent accelerator: 0.1-3 parts.

Preferably, the viscosity of the low viscosity epoxy resin is bisphenol F epoxy resin, with epoxy equivalent of 160-180 and viscosity of 2000-5000 mPa·s.

Preferably, the bisphenol A epoxy resin has epoxy equivalent of 184-200 and viscosity of 10000-18000 mPa·s.

Preferably, the wetting dispersant is one or a combination of more of BYK-310, TEGO KL245, KYC-643 and BYK-W9010. The internal mold discharging agent is one or a combination of more of INT-1890M and MR-3908.

Preferably, the liquid anhydride is one or a combination of more of methyl tetrahydrophthalic anhydride (MeTHPA), methyl hexahydrophthalic anhydride (MeHHPA) and methyl nadic anhydride (NMA).

Preferably, the toughening agent is one or a combination of more of polyester polyol, carbamate prepolymer, modified polyether, carboxylated-terminated acrylonitrile rubber and polypropylene glycol diglycidyl ether.

Preferably, the general accelerator is one of 1-imidazole, 2-imidazole, 2-ethyl-4-methylimidazole, benzyldimethylamine and DMP-30.

Preferably, the latent accelerator is one or a combination of more of benzyldimethylamine, modified dicyandiamide, organic acylhydrazine and diaminomaleonitrile.

A preparation method for the epoxy resin compound for pultrusion of composites in the present invention comprises the following steps:
S1, preparing the component A: weighing the bisphenol A epoxy resin, the low viscosity epoxy resin, the wetting dispersant, the defoamer and the internal mold discharging agent in proportion, adding the mixture to a reaction kettle for stirring, heating to 60±2° C., and preserving heat and stirring for 30-120 min to obtain the component A:
S2, preparing the component B:
S2-1, weighing the general accelerator and the latent accelerator in proportion, and heating and melting after mixing for later use;
S2-2, weighing the liquid anhydride and the toughening agent in proportion, and then adding the mixture to the reaction kettle for mixing and stirring, heating to 80±2° C., and then adding the accelerator mixture melted in the step S2-1 to the reaction kettle, and continuing to stir at 80±2° C. for 30-60 min to obtain the component B;
S3, mixing the component A and the component B in proportion to obtain the epoxy resin compound of the present invention.

Preferably, stirring speed in step S1 is 50-300 r/min; and stirring speed in step S2 is 55-200 r/min.

Compared with the prior art, the present invention has the following beneficial effects:

The present invention provides an epoxy resin compound with low viscosity and long pot life. The epoxy resin compound in the present invention is used for the pultrusion technology of composites. When the temperature of the technology reaches medium and high temperature, the curing time of the epoxy resin compound of the present invention is 80 s to 120 s, and the cured resin has excellent mechanical properties and thermal properties. It can satisfy the requirements of pultrusion technology.

### DESCRIPTION OF DRAWINGS

FIG. 1 is a schematic diagram of pultrusion process of composites.

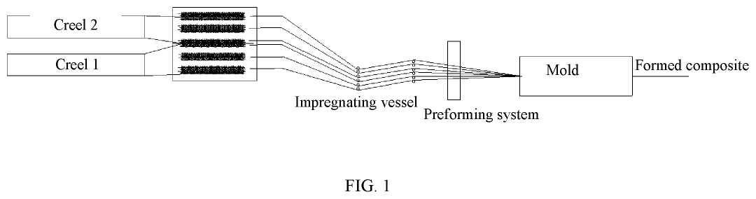

FIG. 2 shows viscosity change curves of epoxy resin compounds in embodiments 1-3 of the present invention.

### DETAILED DESCRIPTION

The present invention will be further described below in combination with specific embodiments.

### Embodiment 1

A preparation method for an epoxy resin compound for pultrusion of composites specifically comprises:
S1, preparing a component A: weighing 30 parts by weight of bisphenol A epoxy resin (with epoxy equivalent of 189 and viscosity of 11700), 70 parts by weight of bisphenol F epoxy resin (with epoxy equivalent of 173 and viscosity of 3190), 5 parts by weight of wetting dispersant (BYK-W9010), 1 part by weight of defoamer (BYK-A530) and 5 parts by weight of internal mold discharging agent (MR-3908), adding to a reaction kettle for stirring at stirring speed of 120 r/min, heating to 60° C., and preserving heat and stirring for 60 min to obtain the component A;
S2, preparing the component B:
S2-1, weighing 1 part by weight of general accelerator (1-imidazole) and 1 part by weight of latent accelerator (modified dicyandiamide), and heating and melting after mixing for later use;
S2-2, weighing 50 parts by weight of liquid anhydride (compound mixture of methyl tetrahydrophthalic anhydride, methyl hexahydrophthalic anhydride and methyl nadic anhydride) and 5 parts by weight of toughening agent (modified polyether), and then adding the mixture to the reaction kettle for mixing and stirring; heating to 80±2° C., and then adding the accelerator mixture melted in the step S2-1 to the reaction kettle; and continuing to stir at 80±2° C. for 45 min at stirring speed of 90 r/min to obtain the component B;
S3, mixing the component A and the component B at a weight ratio of 100:90 to obtain the epoxy resin compound of the present invention.

### Embodiment 2

A preparation method for an epoxy resin compound for pultrusion of composites specifically comprises:
S1, preparing a component A: weighing 50 parts by weight of bisphenol A epoxy resin (with epoxy equivalent of 189 and viscosity of 11700), 50 parts by weight of bisphenol F epoxy resin (with epoxy equivalent of 173 and viscosity of 3190), 15 parts by weight of wetting dispersant (BYK-W9010), 0.5 part by weight of defoamer (BYK-A530) and 5 parts by weight of internal mold discharging agent (MR-3908), adding to a reaction kettle for stirring at stirring speed of 150 r/min, heating to 60±2° C., and preserving heat and stirring for 100 min to obtain the component A;
S2, preparing the component B:
S2-1, weighing 1 part by weight of general accelerator (1-imidazole) and 2 parts by weight of latent accelerator (modified dicyandiamide), and heating and melting after mixing for later use;
S2-2, weighing 80 parts by weight of liquid anhydride (compound mixture of methyl tetrahydrophthalic anhydride, methyl hexahydrophthalic anhydride and methyl nadic anhydride) and 1 part by weight of toughening agent (modified polyether), and then adding the mixture to the reaction kettle for mixing and stirring; heating to 80±2° C., and then adding the accelerator mixture melted in the step S2-1 to the reaction kettle, and continuing to stir at 80±2° C. for 60 min at stirring speed of 150 r/min to obtain the component B;
S3, mixing the component A and the component B at a weight ratio of 100:80 to obtain the epoxy resin compound of the present invention.

### Embodiment 3

A preparation method for an epoxy resin compound for pultrusion of composites specifically comprises:
S1, preparing a component A: weighing 35 parts by weight of bisphenol A epoxy resin (with epoxy equivalent of 189 and viscosity of 11700), 60 parts by weight of bisphenol F epoxy resin (with epoxy equivalent of 173 and viscosity of 3190), 2 parts by weight of wetting dispersant (BYK-W9010), 1 part by weight of defoamer (BYK-A530) and 5 parts by weight of internal mold discharging agent (MR-3908), adding to a reaction kettle for stirring at stirring speed of 300 r/min, heating to 60±2° C., and preserving heat and stirring for 50 min to obtain the component A;
S2, preparing the component B:
S2-1, weighing 2.5 parts by weight of general accelerator (1-imidazole) and 1.2 parts by weight of latent accelerator (modified dicyandiamide), and heating and melting after mixing for later use;
S2-2, weighing 50 parts by weight of liquid anhydride (compound mixture of methyl tetrahydrophthalic anhydride, methyl hexahydrophthalic anhydride and methyl nadic anhydride) and 4 parts by weight of toughening agent (modified polyether), and then adding the mixture to the reaction kettle for mixing and stirring; heating to 80±2° C., and then adding the accelerator mixture melted in the step S2-1 to the reaction kettle; and continuing to stir at 80±2° C. for 40 min at stirring speed of 100 r/min to obtain the component B;
S3, mixing the component A and the component B at a weight ratio of 100:120 to obtain the epoxy resin compound of the present invention.

### Embodiment 4

A preparation method for an epoxy resin compound for pultrusion of composites specifically comprises:
S1, preparing a component A: weighing 75 parts by weight of bisphenol A epoxy resin (with epoxy equivalent of 189 and viscosity of 11700), 25 parts by weight of bisphenol F epoxy resin (with epoxy equivalent of 173 and viscosity of 3190), 5 parts by weight of wetting dispersant (BYK-W9010), 0.9 part by weight of defoamer (BYK-A530) and 6 parts by weight of internal mold discharging agent (MR-3908), adding to a reaction kettle for stirring at stirring speed of 150 r/min, heating to 60±2° C., and preserving heat and stirring for 50 min to obtain the component A;
S2, preparing the component B:
S2-1, weighing 1.5 parts by weight of general accelerator (1-imidazole) and 0.3 part by weight of latent accelerator (modified dicyandiamide), and heating and melting after mixing for later use;
S2-2, weighing 50 parts by weight of liquid anhydride (compound mixture of methyl tetrahydrophthalic anhydride, methyl hexahydrophthalic anhydride and methyl nadic anhydride) and 3 parts by weight of toughening agent (modified polyether), and then adding the mixture to the reaction kettle for mixing and stirring; heating to 80±2° C., and then adding the accelerator mixture melted in the step S2-1 to the reaction kettle; and continuing to stir at 80±2° C. for 50 min at stirring speed of 100 r/min to obtain the component B;
S3, mixing the component A and the component B at a weight ratio of 100:100 to obtain the epoxy resin compound of the present invention.

### Reference Example 1

A preparation method for an epoxy resin compound for pultrusion of composites specifically comprises:
S1, preparing a component A: weighing 30 parts by weight of bisphenol A epoxy resin (with epoxy equivalent of 189 and viscosity of 11700), 70 parts by weight of bisphenol F epoxy resin (with epoxy equivalent of 173 and viscosity of 3190), 5 parts by weight of wetting dispersant (BYK-W9010), 1 part by weight of defoamer (BYK-A530) and 5 parts by weight of internal mold discharging agent (MR-3908), adding to a reaction kettle for stirring at stirring speed of 120 r/min, heating to 60° C., and preserving heat and stirring for 60 min to obtain the component A;
S2, preparing the component B:
S2-1, weighing 5 parts by weight of latent accelerator (modified dicyandiamide), and heating and melting after mixing for later use;
S2-2, weighing 50 parts by weight of liquid anhydride (compound mixture of methyl tetrahydrophthalic anhydride, methyl hexahydrophthalic anhydride and methyl nadic anhydride) and 5 parts by weight of toughening agent (modified polyether), and then adding the mixture to the reaction kettle for mixing and stirring; heating to 80±2° C., and then adding the accelerator mixture melted in the step S2-1 to the reaction kettle, and continuing to stir at 80±2° C. for 45 min at stirring speed of 90 r/min to obtain the component B;
S3, mixing the component A and the component B at a weight ratio of 100:90 to obtain the epoxy resin compound of the present invention.

### Reference Example 2

A preparation method for an epoxy resin compound for pultrusion of composites specifically comprises:
S1, preparing a component A: weighing 30 parts by weight of bisphenol A epoxy resin (with epoxy equivalent of 189 and viscosity of 11700), 70 parts by weight of bisphenol F epoxy resin (with epoxy equivalent of 173 and viscosity of 3190), 5 parts by weight of wetting dispersant (BYK-W9010), 1 part by weight of defoamer (BYK-A530) and 5 parts by weight of internal mold discharging agent (MR-3908), adding to a reaction kettle for stirring at stirring speed of 120 r/min, heating to 60° C., and preserving heat and stirring for 60 min to obtain the component A;
S2, preparing the component B:
S2-1, weighing 5 parts by weight of general accelerator (1-imidazole), and heating and melting after mixing for later use;
S2-2, weighing 50 parts by weight of liquid anhydride (compound mixture of methyl tetrahydrophthalic anhydride, methyl hexahydrophthalic anhydride and methyl nadic anhydride) and 5 parts by weight of toughening agent (modified polyether), and then adding the mixture to the reaction kettle for mixing and stirring; heating to 80±2° C., and then adding the accelerator mixture melted in the step S2-1 to the reaction kettle, and continuing to stir at 80±2° C. for 45 min at stirring speed of 90 r/min to obtain the component B;
S3, mixing the component A and the component B at a weight ratio of 100:90 to obtain the epoxy resin compound of the present invention.

Performance tests are performed on the epoxy resin compounds prepared in embodiment 1 and reference examples 1-2. Test results are shown in Table 1.

TABLE 1
Performance Test Results of Embodiment 1 and Reference Examples 1-2

| | Test Item | | | | | |
|---|---|---|---|---|---|---|
| | | Gelation | Tensile | | | |
| | Viscosity | Time | Strength | Elongation | | |
| | (25° C., | (150° C., | after Curing | after Curing | Cured Tg | |
| Groups | mPa · s) | sec) | (MPa) | (%) | (DSC, ° C.) | Remarks |
| Embodiment 1 | 442 | 63 | 74 | 3.8 | 133 | The gelation |
| Reference | 421 | 273 | 69 | 3.7 | 121 | time is the |
| example 1 | | | | | | semi-cured |
| Reference | 453 | 105 | 71 | 3.8 | 124 | state time of |
| example 2 | | | | | | 2-5 g of |
| | | | | | | mixed resin |

TABLE 2
Basic Properties of Epoxy Resin for Pultrusion Technology
of Composites

| Test Item | Test Data |
|---|---|
| Initial viscosity of A\B mixture (25° C., | <500 |
| mPa · s) | |
| Gelation time (sec) at 150° C. | 70-110 |
| Cured Tg (DSC, ° C.) | >120 |
| Tensile strength (MPa) | ≥65 |
| Tensile modulus (GPa) | ≥2.7 |
| Elongation (%) | ≥3.5 |
| Bending strength (MPa) | ≥110 |
| Bending modulus (GPa) | ≥2.8 |

Remarks: 1. The gelation time is the semi-cured state time of 2-5 g of mixed resin.
2. The test data is the test data after complete curing of the mixed resin compound.

It can be seen from Table 2 that the epoxy resin compound prepared by embodiment 1 of the present invention can satisfy the needs of the pultrusion technology of composites.

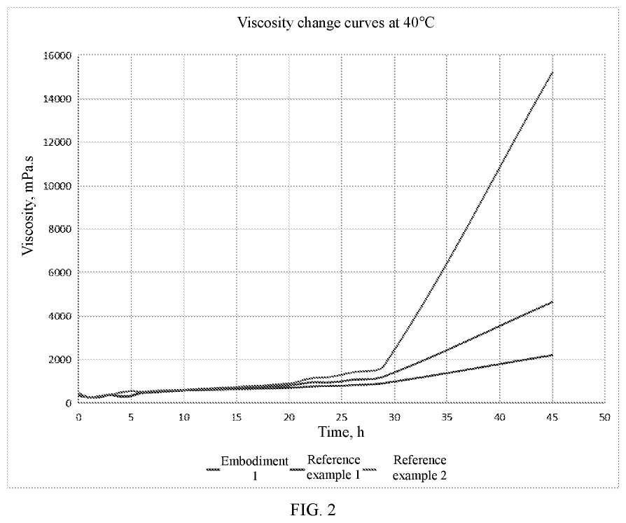

Viscosity detection is performed on the epoxy resin compounds prepared in embodiment 1 and reference examples 1-2 in a constant temperature device at 40° C. Details are shown in FIG. 2.

It should be noted that the above only lists several specific embodiments of the present invention. Obviously, the present invention is not limited to the above embodiments, and can also have other variations. All variations directly derived or indirectly extended from the disclosure of the present invention by those skilled in the art shall be considered to be the protection scope of the present invention.

What is claimed is:

1. An epoxy resin compound for pultrusion of composites, wherein the epoxy resin compound is composed of a component A and a component B at a weight ratio of 100:(80-120);
the component A is composed of the following raw materials in parts by weight:
bisphenol A epoxy resin: 25-75 parts,
low viscosity epoxy resin: 25-75 parts,
wetting dispersant: 1-20 parts,
defoamer: 0.01-1 part,
internal mold discharging agent: 1-10 parts,
the component B is composed of the following raw materials in parts by weight:
liquid anhydride: 50-100 parts,
toughening agent: 1-10 parts,
general accelerator: 0.1-3 parts,
latent accelerator: 0.1-3 parts.

2. The epoxy resin compound for pultrusion of composites according to claim 1, wherein the viscosity of the low viscosity epoxy resin is bisphenol F epoxy resin, with epoxy equivalent of 160-180 and viscosity of 2000-5000.

3. The epoxy resin compound for pultrusion of composites according to claim 1, wherein the bisphenol A epoxy resin has epoxy equivalent of 184-200 and viscosity of 10000-18000.

4. The epoxy resin compound for pultrusion of composites according to claim 1, wherein the wetting dispersant is one or a combination of more of BYK-310, TEGO KL245, KYC-643 and BYK-W9010, and the internal mold discharging agent is one or a combination of more of INT-1890M and MR-3908.

5. The epoxy resin compound for pultrusion of composites according to claim 1, wherein the liquid anhydride is one or a combination of more of methyl tetrahydrophthalic anhydride, methyl hexahydrophthalic anhydride and methyl nadic anhydride.

6. The epoxy resin compound for pultrusion of composites according to claim 1, wherein the toughening agent is one or a combination of more of polyester polyol, carbamate prepolymer, modified polyether, carboxylated-terminated acrylonitrile rubber and polypropylene glycol diglycidyl ether.

7. The epoxy resin compound for pultrusion of composites according to claim 1, wherein the general accelerator is one of 1-imidazole, 2-imidazole, 2-ethyl-4-methylimidazole, benzyldimethylamine and DMP-30.

8. The epoxy resin compound for pultrusion of composites according to claim 1, wherein the latent accelerator is one or a combination of more of benzyldimethylamine, modified dicyandiamide, organic acylhydrazine and diaminomaleonitrile.

9. A preparation method for the epoxy resin compound for pultrusion of composites of claim 1, comprising the following steps:
S1, preparing the component A: weighing the bisphenol A epoxy resin, the low viscosity epoxy resin, the wetting dispersant, the defoamer and the internal mold discharging agent in proportion, adding to a reaction kettle for stirring, heating to 60±2° C., and preserving heat and stirring for 30-120 min to obtain the component A:
S2, preparing the component B:
S2-1, weighing the general accelerator and the latent accelerator in proportion, and heating and melting after mixing for later use;
S2-2, weighing the liquid anhydride and the toughening agent in proportion, and then adding to the reaction kettle for mixing and stirring; heating to 80±2° C., and then adding the accelerator mixture melted in the step S2-1; and continuing to stir at 80±2° C. for 30-60 min to obtain the component B;
S3, mixing the component A and the component B in proportion to obtain the epoxy resin compound of the present invention.

10. The preparation method for the epoxy resin compound for pultrusion of composites according to claim 9, wherein stirring speed in step S1 is 50-300 r/min; and stirring speed in step S2 is 55-200 r/min.
